(19) United States
(12) Patent Application Publication
(10) Pub. No.: US 2006/0288846 A1
(43) Pub. Date: Dec. 28, 2006

(54) Music-based exercise motivation aid

(76) Inventor: Beth T. Logan, Cambridge, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/169,237

(22) Filed: Jun. 27, 2005

(51) Int. Cl. G10H 7/00

(52) U.S. Cl. 84/612

(57) ABSTRACT

A music segment reproducing device comprises a music segment processing unit for tempo morphing an input music segment into an output music segment. The device includes a control unit for interfacing with a user and receiving a desired cadence as an input and a memory unit for storing input and output music segments. A music segment can be a song. The tempo of the input music segment is changed to correspond to the desired cadence without substantially changing the pitch of the input music segment. The device can include a music segment reproducing unit for reading the output music segment from the memory unit and reproducing the output music segment as an analog waveform via headphones or speakers.

### BACKGROUND OF THE INVENTION

Most runners measure their progress by their “splits”, that is the time to run a set distance. For example, in a 10k race, a runner may know that she can run 8 minute miles and may train to improve this to 7:50 minute miles. Training may involve increasing the stride length and/or improving cadence or pace (number of steps or other movements per minute). It is known, for example, that elite athletes run at a certain cadence (around 180 steps per minute) regardless of the terrain or distance traveled per step. (Jack Daniels, Ph.D., “Daniels' Running Formula”, Human Kinetics, 2005, 1998). The theory is that this is an efficient running speed for the human body. Therefore, improving and maintaining cadence is of interest to all runners hoping to improve their form. Existing methods to train to the right cadence include running on a treadmill or running with “beeping” metronome-like devices.

### SUMMARY OF THE INVENTION

Many people like to listen to music when they exercise and it is well known that music can promote a sense of well-being and motivation. When running on a treadmill, it is possible to buy music that plays at the right tempo for a given split. However, the music cannot be arbitrarily chosen and must be pre-selected based on the tempo.

The present invention is a device and a method that allows an athlete to play arbitrary music at the tempo required to achieve his personalized exercise goal (cadence).

In one embodiment, the present invention is a music reproducing device, comprising a control unit for interfacing with a user and receiving a desired cadence as an input, a memory unit for storing input and output music and music processing unit for tempo morphing an input music into an output music, wherein the tempo of the input music is changed to correspond to the desired cadence without substantially changing the pitch of the input music. The device can further include a music reproducing unit for reading the output music from the memory unit and reproducing the output music as an analog waveform.

In another embodiment, the present invention is a computer-implemented method of providing a motivational aid to an athlete. The method comprises computing a desired cadence of the exercise routine, selecting an input music, and tempo morphing the input music into an output music. The tempo of the input music is changed to correspond to the desired cadence without substantially changing the pitch of the input music. The method can further include reproducing the output music as an analog waveform.

Advantages of the present invention are numerous. For example, if a runner, while maintaining his stride length, strides at the tempo of the music, he will achieve his split. Not only does the beat of the music serve as a guide but it can motivate an athlete to meet his goals far more than a “beeping” sound of a metronome-type device. Furthermore, the method of the present invention works with arbitrary music further motivating the athlete who selects music specific to his tastes. Because the device of the present invention may be portable, the athlete may exercise outdoors.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a device of the present invention.

FIG. 2 is a schematic diagram of a control unit of the present invention.

FIGS. 3A and B is a schematic diagram illustrating the principles of a typical tempo-morphing algorithm.

### DETAILED DESCRIPTION OF THE INVENTION

The present invention is a device that reproduces a music segment at a user-specified tempo while substantially preserving the pitch of the reproduced music segment. The inventive device operates by subjecting a music segment to tempo morphing, described below in detail. The music segment can be a song. The device is can be portable. The user can be a person or a machine. For example, a user can be an athlete in training, performing rhythmic movements, e.g., a runner.

As used herein, the term “music” refers to vocal, instrumental or mechanical sounds having rhythm, melody or harmony. The term “song” refers to a short musical segment that can optionally include words. As used herein, the term “tempo” refers to a rate of speed of a musical piece or passage. The term “cadence” refers to beat, timing or measure of rhythmical motion or activity.

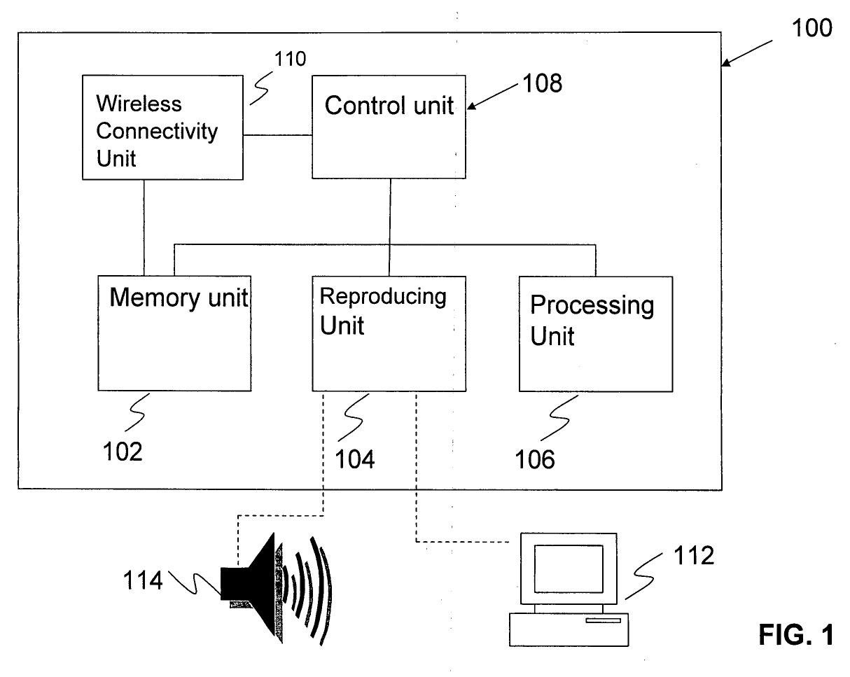

Referring to FIG. 1, device 100 comprises memory unit 102, music segment reproducing unit 104, music segment processing unit 106, and control unit 108. Device 100 can optionally include wireless connectivity unit 110.

Memory unit 102 can be any memory device commonly used to store information, including music. Preferably, music stored on memory unit 102 is in a digital format such as MP3 or WAV. Unit 102 can be, for example, a compact disk or a semiconductor memory device. Unit 102 is a READ/WRITE type device. Memory unit 102 can be built-in or removable. In some embodiments, memory unit 102 can store music in an analog format (e.g., on tape). In such an embodiment, device 100 may further include an analog-to-digital converter to convert the music from an analog format to a digital format.

Music segment reproducing unit 104 reads a music segment from memory unit 102, decodes the signal from a format used to store the program (e.g., MP3 or WAV) into an analog signal and reproduces the music segment via a set of headphones or speakers. Music segment reproducing unit 104 can read music segments from removable information carriers. Examples of such removable carriers are READ ONLY or READ/WRITE compact disks having prerecorded music segments, non-volatile semiconductor memory devices (e.g., EEPROM, FlashDrive®) having pre-stored music segments and other suitable recordable media. A CD player or digital player capable of reproducing music stored in the MP3 format are examples of music segment reproducing unit 104.

Music segment reproducing unit 104 can further include ports for connecting to peripheral devices such as external memory (e.g., music files stored on a hard drive of desktop computer 112) or external audio signal amplifier 114.

The present invention further includes music segment processing unit 106. Unit 106 performs tempo morphing, as will be described below in greater details. Under the direction of control unit 108, which also performs the function of a user interface, a music segment stored on memory unit 102 is accessed by music segment processing unit 106. The program read from memory unit 102 is digitally processed by music segment processing unit 106, whereby the tempo of the music segment is changed without substantially distorting its pitch.

The processed music segment is then either stored on memory unit 102 or externally (see FIG. 1) or passed to music segment reproducing unit 104, which converts the digitally altered music segment into an analog waveform which drives a set of headphones or speakers. The processed music segment can either be stored on memory unit 102 or externally or immediately reproduced by audio reproducing unit 104. In either case, the processed music segment is made accessible for reading by music segment reproducing unit 104. If processing unit 106 has sufficient processing capabilities, the tempo morphing can take place in real time or with a small time delay. Either pre-stored music or music received from AM, FM or Internet radio stations can be used.

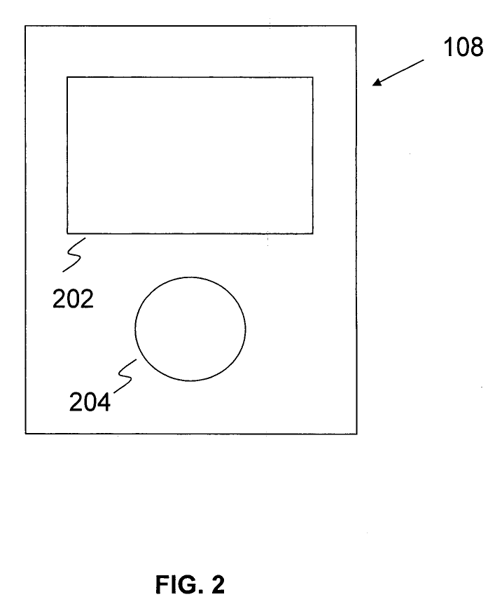

Control unit 108 is shown in FIG. 2. Control unit 108 comprises output device 202 and an input device 204. Output device 202 is preferably a display, for example a CRT-based, LCD-based or a gas-plasma-based flat panel display. Input device 204 can be a mouse-type device or a keyboard. Preferably, input device 204 allows the stride length of a user to be inputted. Output device 202 can display a menu option, which, upon selection using input device 204, starts the processing of a selected music segment. In one embodiment, output device 202 displays a set of pre-loaded stride lengths while input device 204 allows the user to cycle through them and choose the right one.

Referring to FIG. 1, control unit 108 takes input from a user and selects the stored music segment to be reproduced, controls the extent to which the selected program's tempo is changed as well as priority of access of memory unit 102 by units 104, 106 and optional wireless connectivity unit 110.

Optional wireless connectivity unit 110 allows device 100 to access remote sources of music segments over a wireless local area network (WLAN) and store music segments available through the WLAN into memory unit 102. In one embodiment, wireless connectivity unit 110 includes a frequency and/or amplitude modulation radio receiver that allows device 100 to access music segments broadcast over radio waves and store them to memory unit 102.

Music segment processing unit 106 can implement any of the known algorithms for changing the tempo of a music segment without changing the pitch of the audio signal (tempo morphing).

While the pitch of an audio signal depends on the frequencies of the tones that comprise such signal, the pitch perception is as much a physical as it is a psychological phenomenon. Pitch perceived by a human listener is defined by the relative presence of harmonics and non-harmonic overtones in the audio spectrum. Heightened or lowered pitch is a well-known side-effect of increasing or decreasing music tempo, respectively. The aim of tempo morphing is to modify the perceived speed of a music segment while preserving the spectral characteristics. If the spectral characteristics remain the same then the pitch and instrumentation will be perceived as similar to the original program.

Generally, algorithms that change the tempo without substantially affecting the pitch process an audio signal in two steps: (i) detecting beats of a music segment, and (ii) modifying the perceived music segment tempo while preserving the spectral characteristics of the audio signal.

Detection of a dominant beat of a music segment is described, for example, in E. D. Scheirer, “Tempo and beat analysis of acoustic music signals”, Journal of Acoustical Society of America, vol. 103, no. 1, pp. 588-601, January 1998, the entire teachings of which is herein incorporated by reference. Beats in music are crudely characterized by local maximums of acoustic energy (loudness). In other words, if a first portion of a music segment is louder than the portions that precede and follow the first portion, the ear perceives the first portion as a beat. Relying on this feature of human perception, beat detection algorithms compare the acoustic energy (loudness) of the shorter portion of a music segment having a specified length to the acoustic energy (loudness) of a longer portion of the music segment, wherein the longer portion comprises the shorter portion. For example, loudness of a 25 milliseconds (ms) portion of a music segment may be compared to loudness of a 1 second segment that comprises the 25 ms portion. If the difference in energy (loudness) is greater than a preset threshold, then a beat is detected.

More complex algorithms, capable of detecting beats in polyphonically complex music also exist. Humans detect beats in polyphonic music by detecting whether one instrument starts just as another one stops. In such a case, humans perceive a beat but the acoustic energy (loudness) could remain the same. To account for this phenomenon, certain beat detection algorithms compute energy in frequency sub-bands. Different instruments have different spectral characteristics and computing energy in sub-bands highlights timbral changes which could correspond to beats even if the total energy stays constant.

Still other beat detection algorithms compute frequency sub-bands using perceptual (rather than linear) frequency scales, passing the source signal through a differentiator to make variations in the amplitude more marked and hence beat detection easier, and using comb filters over several seconds of data to find the most regular set of hypothesized beats.

Once the beats are detected, the tempo of a music segment is digitally altered to achieve the tempo inputted by the user using control unit 108. For example, if the original tempo is 100 beats per minute and the desired tempo is 120 beats per minute, then the tempo is increased by 20%. Such an alteration is possible without changing the pitch of the music segment by using known algorithms such as D. Dorran and R. Lawlor, “An efficient audio time-scale modification algorithm for use in a subband implementation,” Proceedings of the 6^{th} International Conference on Digital Audio Effects (DAFX-03), London, September 2003, the entire teaching of which is incorporated herein by reference.

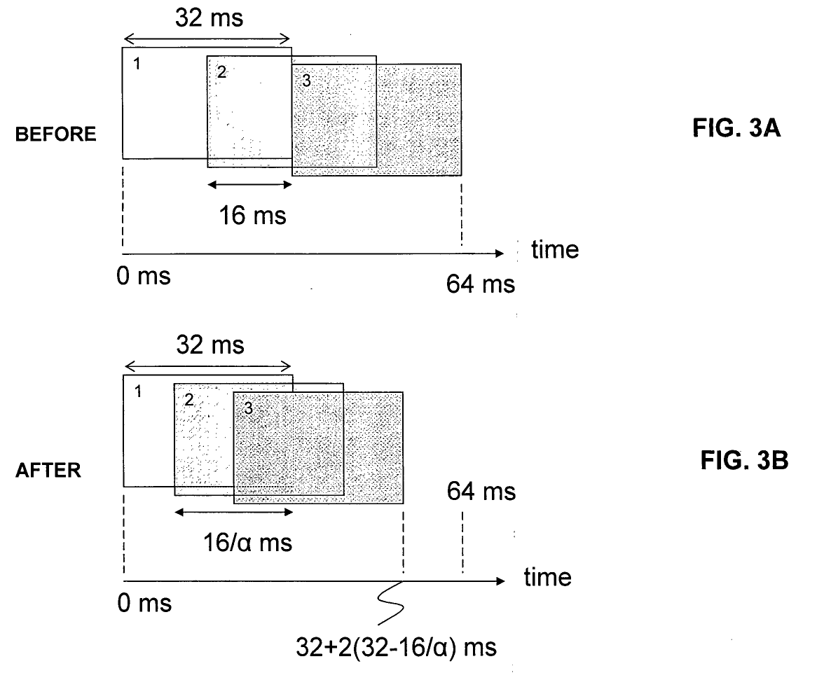

An operation of an exemplary time-scale-based algorithm for tempo alteration without substantially changing the pitch is illustrated in FIGS. 3A and 3B. The music segment into overlapping frames. FIG. 3A shows three such frames. In this example, each frame has a length of 32 ms and the length of the overlap is 16 ms. FIG. 3B shows the same three frames in a newly processed program. The processed program of FIG. 3B is formed by changing the length of the overlay of the frames by a factor of 1/α, where α is integer. If the program tempo is increased, α<1; if the tempo is decreased, α>1.

In order to minimize spectral distortion when forming the new signal, the length of the new overlay is not uniform among all frames. Referring to FIG. 3B, if all frames are overlaid at exactly 16/α ms, some distortion will result. To counteract this distortion, the “Synchronized Overlap and Add” (SOLA) algorithm, for example, places frames so that while the average length of the overlay is 16/α±6 ms, a small amount of variation in overlay is allowed. This variation is chosen so that the next frame is added to the previous frame at a “good” location, i.e. so that beats in the next frame “line up” with the beats in the program formed thus far. For example, the length of the overlay could be 16/α±6 ms. As a result, human listener perceives fewer distortions in the music segment.

Many variations on this basic algorithm exist such as using functions other than cross-correlation to select a good location for the next frame as well as allowing different amounts of variation when selecting the location of the next frame. Algorithms which select the next frame location according to sub-bands in the frequency domain also exist. These algorithms account for music which does not have readily identifiable beats.

As mentioned above, a user of the device of the present invention can be an athlete in training, performing rhythmic movements, e.g., a runner. The description below uses a runner as an example. It is understood, however, that a person performing any type of physical activity involving rhythmic movements can also use the device of the present invention. The device of the present invention can also apply to other “rhythmic and mobile” sports such as walking, cycling, rowing, skipping, cross-country skiing, etc., in which it is desirable to maintain a steady rhythm. In some of these cases, the relationship between stride length and cadence is replaced by an estimate of the number of beats required per minute to achieve the desired goal. Further uses of the present invention include medical/rehabilitation purposes where the desired cadence is set by a medical professional.

During a typical use of a device of the present invention, an athlete first computes his stride length. This need only take place occasionally. Stride length can be computed using a commercial pedometer or simply by counting the steps taken when running over a known distance. It should be noted that this stride length is only valid for the terrain on which it was recorded e.g., flat terrain, slight hill, etc. It is trivial however to record stride lengths for various terrains and use these in different training routines.

Given the known stride length, the cadence required to achieve a desired pace can be computed, for example by control unit 108 (FIG. 1), as:
Cadence (beats/minute)=1/(desired minutes/mile)*1/(number of miles/step).

The tempo of a set of training music segment is then processed to match this cadence as described above. The processed music is stored either in memory unit 102 of device 100 (FIG. 1) or externally.

If certain music segments, e.g. songs, require less tempo morphing than others (and hence will be less distorted for a given value of the desired tempo), these songs can be preferentially presented to a user by control unit 108, which performs the function of a user interface (see FIG. 2). In this case, the songs most amenable to tempo morphing can be highlighted on the screen. Furthermore, songs can be sorted (either externally or in memory unit 102) based on the closeness of the beat to the required cadence.

The device of present invention can be used to construct training programs consisting of more than one pace. For example, an exercise routine can include a warm-up portion at a slow pace followed by a fast pace portion, followed by a slow cool-down portion.

While this invention has been particularly shown and described with references to preferred embodiments thereof, it will be understood by those skilled in the art that various changes in form and details may be made therein without departing from the scope of the invention encompassed by the appended claims.

What is claimed is:

1. A music segment reproducing device, comprising:
a control unit for interfacing with a user and receiving a cadence value as an input;
a memory unit for storing input and output music segments; and
a music segment processing unit for tempo morphing an input music segment into an output music segment, wherein the tempo of the input music segment is changed to correspond to the cadence value without substantially changing the pitch of the input music segment.

2. The device of claim 1, further including:
a music segment reproducing unit for reading the output music segment from the memory unit and reproducing the output music segment as an analog waveform.

3. The device of claim 1 further including:
a wireless connectivity unit for accessing remote sources of input music segments and optionally storing said input music segments on the memory unit.

4. The device of claim 1, wherein the music segment reproducing unit reads input music segments from a removable recordable media and optionally stores said read input music segments in the memory unit.

5. The device of claim 1, wherein the input music segments stored on the memory unit are sorted based on the closeness of the music segment tempo to the cadence value.

6. The device of claim 1, wherein the input music segments are preferentially displayed by the control unit based on the closeness of the music segment tempo to the cadence value.

7. The device of claim 1, wherein the music segment is a song.

8. A computer implemented method of providing a motivational aid to an athlete, comprising:
computing a cadence value for an exercise routine;
selecting an input music segment; and
tempo morphing the input music segment into an output music segment, whereby the tempo of the input music segment is changed to correspond to the cadence value without substantially changing the pitch of the input music segment.

9. The method of claim 8 further including:
reproducing the output music segment as an analog waveform.

10. The method of claim 8 further including:
accessing a remote source of music segments via wireless local area network or radio waves.

11. The method of claim 8 further including:
reading input music segments from a removable recordable media.

12. The method of claim 8 further including:
selecting the input music segment based on the closeness of the music segment tempo to the cadence value.

13. The device of claim 8, wherein the music segment is a song.
